(19) United States
(12) Patent Application Publication
(10) Pub. No.: US 2002/0109804 A1
(43) Pub. Date: Aug. 15, 2002

(54) Liquid crystal display device

(75) Inventors: Masaki Tsubokura, Mobara (JP); Shinji Matsumoto, Ooami (JP); Tatsuyuki Fumikura, Mobara (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 10/054,998

(22) Filed: Jan. 25, 2002

(30) Foreign Application Priority Data
Feb. 13, 2001 (JP) 2001-035139

(51) Int. Cl. G02F 1/1335

(52) U.S. Cl. 349/58

(57) ABSTRACT

A liquid crystal display device includes a liquid crystal display element having a pair of substrates and liquid crystal sandwiched between a pair of substrates and a backlight unit which is arranged at a side opposite to a display surface of the liquid crystal display element, wherein the backlight unit comprises a light guide body, plural light sources which are arranged at least along one side surface of the light guide body in the direction perpendicular to a display surface of the liquid crystal display element and irradiates the irradiation light to the liquid crystal display element, a reflection member which covers the plural light sources and has shielding means which is arranged between each two light sources of the plural light sources, and a housing member which houses the light guide body, the plural light sources and the reflection member.

### BACKGROUND OF THE INVENTION

The present invention relates to a liquid crystal display device served for a personal computer, a work station or the like, and more particularly, to a technique which can be effectively applied to a sidelight backlight unit used in the liquid crystal display device.

Liquid crystal display modules of a STN (Super Twisted Nematic) type or a TFT (thin film transistor) type have been broadly used as notebook type personal computers or the like.

The liquid crystal display module is constituted of a liquid crystal display panel which arranges a drain driver and a gate driver on a periphery thereof and a backlight unit which irradiates light to the liquid crystal display panel.

The backlight unit is roughly classified into a sidelight backlight unit and a direct backlight unit.

As the liquid crystal display module which is used as the display device for the notebook type personal computer, the sidelight backlight unit is mainly adopted.

The sidelight backlight unit is constituted by accommodating, for example, a light guide body which guides light irradiated from a light source in the direction away from the light source and irradiates the light uniformly over the whole liquid crystal display panel, a cold cathode fluorescent lamp which is arranged in the vicinity of a side surface of the light guide body and in parallel and along with the side surface of the light guide body and forms a linear light source, optical sheets (for example, two diffusion sheets and two prism sheets) which are arranged on the light guide body, and a reflection sheet which is arranged below the light guide body in an extended manner in a mold.

Such a technique is described in, for example, Japanese Patent Publication 19474/1985 and Japanese Utility Model Laid-open Publication 22780/1992.

Recently, the liquid crystal display modules have become large-sized and have been provided with large screens and hence, the liquid crystal display modules have been used also as display devices for monitoring.

With respect to the liquid crystal display modules for monitoring which are large-sized, have large screens and adopt sidelight backlight units, there has been known a liquid crystal display module which uses two cold cathode fluorescent lamps for enhancing the brightness.

However, in such a sidelight backlight unit which arranges two cold cathode fluorescent lamps in the inside thereof, two cold cathode fluorescent lamps are arranged close to each other in a narrow space along a side surface of a light guide body.

Accordingly, each cold cathode fluorescent lamp receives light directly from the other cold cathode fluorescent lamp so that the temperature of each cold cathode fluorescent lamp is elevated due to the radiation heat.

In general, as shown in FIG. 6, there exists a temperature at which the cold cathode fluorescent lamp exhibits the maximum illumination efficiency (the maximum brightness) and when the temperature of the cold cathode fluorescent lamp becomes higher than such a temperature, the illumination efficiency is sharply reduced and the brightness is reduced correspondingly.

In this manner, with respect to the sidelight backlight unit which arranges two cold cathode fluorescent lamps in the inside thereof, there has been a drawback that the temperature of respective cold cathode fluorescent lamps is elevated due to the above-mentioned reason so that the brightness of respective cold cathode fluorescent lamps is reduced.

### SUMMARY OF THE INVENTION

The present invention has been made to overcome these problems of the related art and it is an object of the present invention to provide, in a liquid crystal display device adopting a sidelight backlight unit which accommodates a plurality of light sources in the inside thereof, a technique which can prevent the elevation of the temperature of each cold cathode fluorescent lamp caused by the radiation heat from other light source and can prevent the lowering of the brightness of each light source accordingly.

The above-mentioned object, other objects and novel features of the present invention will be made apparent based on the description of this specification and attached drawings.

Among the inventions disclosed in the present application, to briefly explain the summary of typical inventions, they are as follows.

That is, the present invention is directed to a liquid crystal display device which includes a liquid crystal display element having a pair of substrates and liquid crystal sandwiched between a pair of substrates and a backlight unit which is arranged at a side opposite to a display surface of the liquid crystal display element, wherein the backlight unit includes a light guide body, a plurality of light sources which are arranged at least along one side surface of the light guide body at a plurality of positions whose distances from a display surface of the liquid crystal display element are different from each other and irradiate the illumination light to the light guide body, a reflection member which covers a plurality of light sources and has shielding means which is arranged between each two light sources of a plurality of light sources, and a housing member which houses the light guide body, a plurality of light sources and the reflection member.

According to a preferred mode of the present invention, at least two light sources are arranged along one side surface of the light guide body and at least two more light sources are arranged along another side surface of the light guide body which are disposed opposite to the one side surface of the light guide body.

According to another preferred mode of the present invention, surfaces of the reflection member and the shielding means which face the respective light sources in an opposed manner form reflection surfaces.

According to still another preferred mode of the present invention, the reflection member and the shielding means are made of metal.

According to a further preferred mode of the present invention, the housing member is at least partially made of metal and the reflection member is thermally connected with the metal portion of the housing member.

According to the above-mentioned constitutions, in the liquid crystal display device which adopts the sidelight backlight unit arranging a plurality of light sources in the inside thereof, the light shielding means is provided between a plurality of light sources which are arranged close to each other and hence, a phenomenon that the light emitting efficiency of each light source is reduced due to the radiation heat from other light source can be prevented whereby it becomes possible to prevent the reduction of the brightness of the each light source.

Further, since the surfaces of the reflection plate and the shielding means which face the respective light sources in an opposed manner are used as the reflection surfaces, the light irradiated from the respective light sources is efficiently made incident on the light guide body.

Further, when the reflection plate and the light shielding means are made of metal and the reflection plate is thermally connected with the metal portion of the housing member, the heat generated by the each light source per se can be efficiently radiated so that a phenomenon that the temperature of the each light source is elevated and the light emitting efficiency of the each light source is reduced can be prevented.

Accordingly, the brightness of display images displayed on the liquid crystal display element can be enhanced.

### BRIEF DESCRIPTION OF THE DRAWINGS

FIG. 1 is an exploded perspective view showing a general constitution of a TFT type liquid crystal display module according to an embodiment of the present invention.

FIG. 2 is an exploded perspective view showing a general constitution of a backlight unit shown in FIG. 1.

FIG. 3 is a perspective view showing a general constitution of a cold cathode fluorescent lamp shown in FIG. 2.

FIG. 4 is a cross-sectional view showing a general cross-sectional structure of the liquid crystal display module of the embodiment of the present invention.

FIG. 5 is a cross-sectional view showing a general cross-sectional structure of a conventional liquid crystal display module.

FIG. 6 is a graph showing the relationship between the brightness and the temperature of a cold cathode fluorescent lamp 21.

### DESCRIPTION OF THE PREFERRED EMBODIMENTS

Embodiments in which the present invention is applied to a TFT type liquid crystal display module are explained in detail in conjunction with drawings.

In all drawings for explaining the embodiments, parts having identical functions are given same numerals and the repeated explanation of these parts is omitted.

[Constitution of TFT type liquid crystal display module according to embodiment 1 of the present invention]

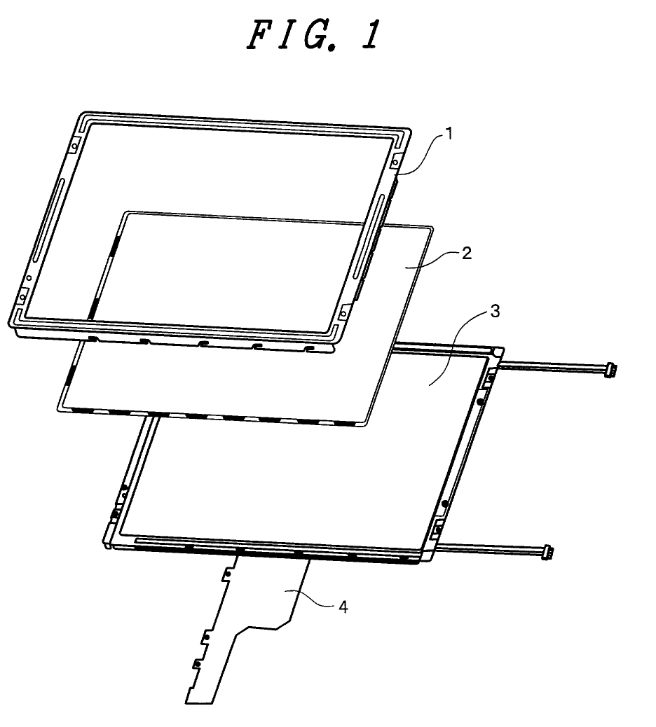

FIG. 1 is an exploded perspective view showing a general constitution of a TFT type liquid crystal display module according to embodiment 1 of the present invention.

The liquid crystal display module of this embodiment is constituted of a rectangular frame 1 made of a metal plate, a liquid crystal display panel (liquid crystal display element of the present invention) 2 and a sidelight backlight unit 3.

The liquid crystal display panel 2 is constituted such that a TFT substrate on which pixel electrodes, thin film transistors and the like are formed and a filter substrate on which a counter electrode, color filters and the like are formed are superposed with a given gap therebetween, both substrates are laminated to each other by means of a frame-like seal member provided in the vicinity of peripheral portions of both substrates, liquid crystal is filled into and is sealed in the inside of the sealing member between both substrates through a liquid crystal filling port formed in a portion of the seal member, and polarizers are laminated to the outsides of both substrates.

Here, a plurality of drain drivers and gate drivers which are constituted of semiconductor integrated circuit devices (IC) are mounted on a glass substrate of the TFT substrate.

A drive power source, display data and control signals are supplied to the drain drivers through a flexible printed wiring board, while the drive power source and control signals are supplied to the gate drivers through a flexible printed wiring board.

These flexible printed wiring boards are connected to a driving circuit board 4 which is provided to the back side of the backlight unit 3.

[Constitution of the backlight unit 3 shown in FIG. 1]

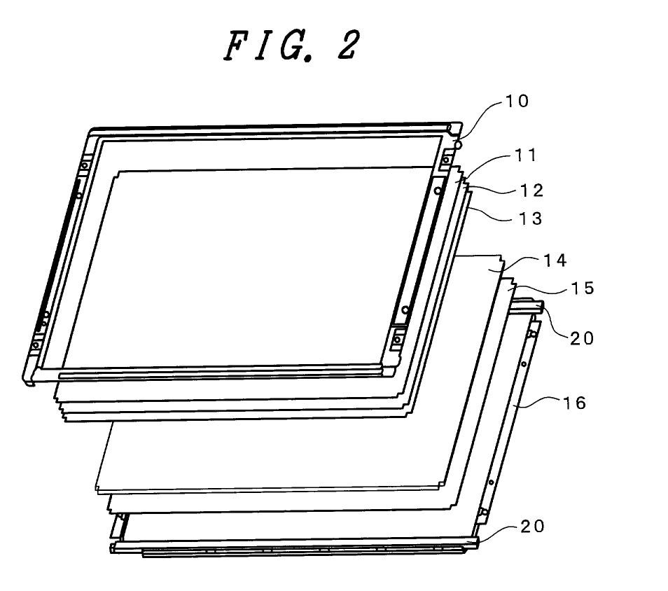

FIG. 2 is an exploded perspective view showing a general constitution of the backlight unit 3 shown in FIG. 1.

As shown in FIG. 2, the backlight unit 3 shown in FIG. 1 is constituted such that an upper diffusion sheet 11, two prism sheets 12, a lower diffusion sheet 13, a light guide body 14, cold cathode fluorescent lamp units 20 and reflection sheets 15 are fitted into a mold 10 which is formed in a frame shape and has a window in the order shown in FIG. 2, and an opening portion of the mold 10 is covered with a lower frame 16 made of a metal plate.

In this embodiment, the cold cathode fluorescent lamp units 20 are arranged along and in the vicinity of two side surfaces of the light guide body 14 which are disposed opposite to each other.

The light guide body 14 having a rectangular shape guides light which is irradiated from cold cathode fluorescent lamps disposed in the inside of the cold cathode fluorescent lamp units 20 in the direction away from the cold cathode fluorescent lamps and uniformly irradiates the light over the whole liquid crystal display panel.

The upper and lower diffusion sheets (11, 13) and two prism sheets (upper and lower prism sheets) 12 are arranged on the light guide body 14, while the reflection sheet 15 is arranged below the light guide body 14.

[General constitution of the cold cathode fluorescent lamp unit 20 shown in FIG. 2]

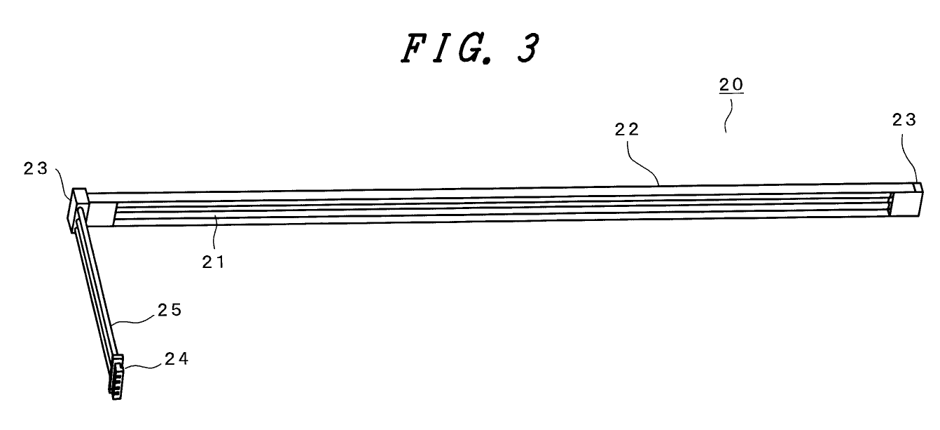

FIG. 3 is a perspective view showing the general constitution of the cold cathode fluorescent lamp unit 20 shown in FIG. 2.

As shown in FIG. 3, the cold cathode fluorescent lamp unit 20 shown in FIG. 1 includes two cold cathode fluorescent lamps 21 around which a reflection plate 22 is arranged.

This reflection plate 22 is made of, for example, metal such as aluminum or synthetic resin and the reflection plate 22 is provided with a shielding plate 30 between two cold cathode fluorescent lamps 21 as will be explained later.

Further, in FIG. 3, numeral 23 indicates a rubber bushing, numeral 24 indicates a connector, and numeral 25 indicates a cable.

[Cross-sectional structure of liquid crystal display module of this embodiment]

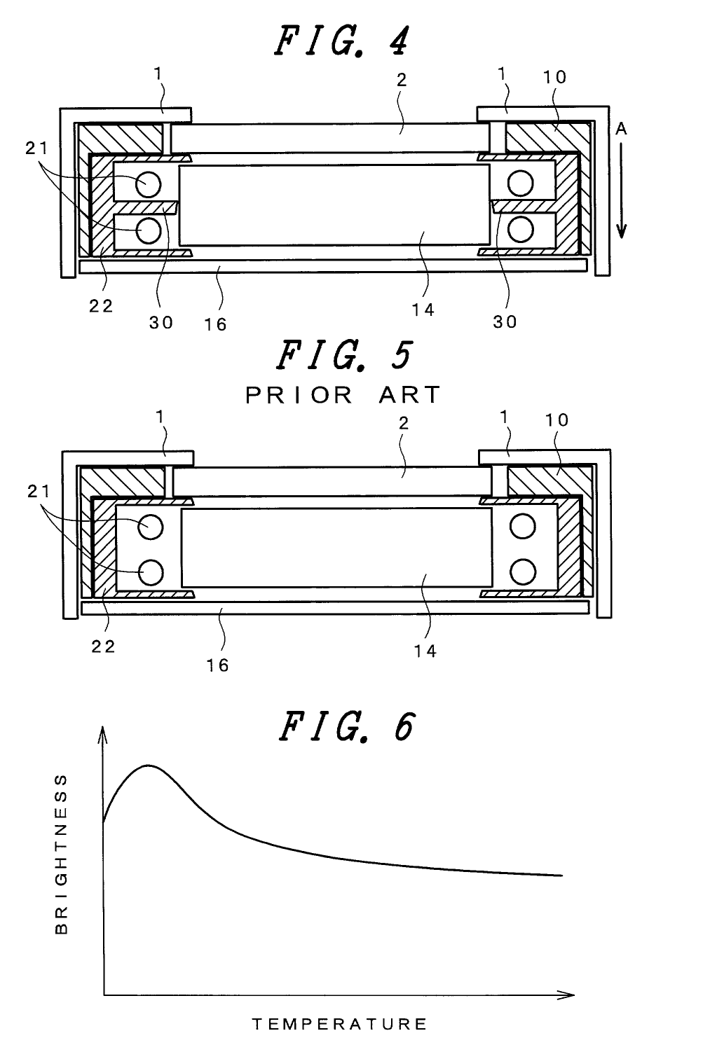

FIG. 4 is a cross-sectional view showing a general cross-sectional structure of the liquid crystal display module of this embodiment.

FIG. 4 shows the cross-sectional structure in the state that the liquid crystal display module is cut along a plane which intersects the cold cathode fluorescent lamps 21 at a right angle. Further, in FIG. 4, the upper and lower diffusion sheets (11, 13), two prism sheets (upper and lower prism sheets) 12 and the reflection sheet 15 are omitted from the drawing.

As shown in FIG. 4, two cold cathode fluorescent lamps 21 are covered with the reflection plate 22 which is provided with the shielding plate 30 between two cold cathode fluorescent lamps 21.

The reflection plate 22 has an approximately E-shaped cross-sectional shape, wherein inner surfaces of the reflection plate 22 and the shielding plate 30 form reflection surfaces and cover approximately the full length of two cold cathode fluorescent lamps 21.

Accordingly, light beams irradiated in directions different from the direction toward the light guide body 14 can be focused on the light guide body 14 without any leaking so that the brightness of display images displayed on the liquid crystal display panel 2 can be enhanced.

[Cross-sectional structure of conventional liquid crystal display module]

FIG. 5 is a cross-sectional view showing a general cross-sectional structure of a conventional liquid crystal display module.

FIG. 5 also shows the cross-sectional structure in the state that the liquid crystal display module is cut along a plane which intersects a cold cathode fluorescent lamps 21 at a right angle. Also in FIG. 5, upper and lower diffusion sheets (11, 13), two prism sheets (upper and lower prism sheets) 12 and a reflection sheet 15 are omitted from the drawing.

As shown in FIG. 5, in a backlight unit of the conventional liquid crystal display module, each reflection plate 22 is not provided with a shielding plate 30 between two cold cathode fluorescent lamps 21.

Accordingly, each cold cathode fluorescent lamp 21 directly receives the irradiation of light from the other cold cathode fluorescent lamp 21 so that the temperature of each cold cathode fluorescent lamp 21 is elevated due to the radiation heat whereby there has been a problem that the brightness of respective cold cathode fluorescent lamps 21 is reduced.

To the contrary, according to the backlight unit 3 of the liquid crystal display module of this embodiment, the reflection plate 22 is provided with the shielding plate 30 which is disposed between two cold cathode fluorescent lamps 21.

Accordingly, in this embodiment, even when two cold cathode fluorescent lamps 21 are arranged close to each other in the inside of a narrow space covered with the reflection plate 22, there exists no possibility that each cold cathode fluorescent lamp 21 directly receives the irradiation of light from the other cold cathode fluorescent lamp 21 and the temperature of each cold cathode fluorescent lamp 21 is elevated due to the radiation heat. Accordingly, it becomes possible to obviate a phenomenon that the brightness of each cold cathode fluorescent lamp 21 is reduced due to the elevation of the temperature of each cold cathode fluorescent lamp 21.

Here, the temperature of each cold cathode fluorescent lamp 21 is also elevated due to heat generated by each cold cathode fluorescent lamp 21 per se besides the above-mentioned radiation heat.

To prevent the elevation of the temperature of each cold cathode fluorescent lamp 21 due to the heat generated by each cold cathode fluorescent lamp 21 per se, in this embodiment, the reflection plate 22 is brought into contact with the lower frame 16 which covers the opening portion of the mold 10.

That is, in this embodiment, since the reflection plate 22 and the lower frame 16 are thermally connected to each other, the heat generated by each cold cathode fluorescent lamp 21 per se can be efficiently radiated through the reflection plate 22 and the lower frame 16. Accordingly, it becomes possible to prevent the phenomenon that the temperature of each cold cathode fluorescent lamp 21 is elevated due to the heat generated by each cold cathode fluorescent lamp 21 per se and the brightness of each cold cathode fluorescent lamp 21 is reduced.

Due to such a constitution, according to this embodiment, the brightness of the display images displayed on the liquid crystal display panel 2 can be enhanced thus realizing the high brightness.

In the previous description, the case in which two cold cathode fluorescent lamps 21 are arranged along the side surfaces of the light guide body 14 which are opposed to each other has been explained. However, the present invention is not limited to such a case. That is, three or more cold cathode fluorescent lamps 21 may be arranged in the direction perpendicular to the display surface of the liquid crystal display panel 2 (the direction indicated by an arrow A in FIG. 4) and the shielding plate 30 may be arranged between each two cold cathode fluorescent lamps 21.

Further, as the light guide body 14, it may be possible to adopt a wedge-shaped light guide body which makes a surface thereof which faces the cold cathode fluorescent lamps 21 have a large width and gradually decreases a cross section thereof in the direction away from the cold cathode fluorescent lamps 21, and a plurality of cold cathode fluorescent lamps 21 are arranged along one side surface of the light guide body 14 having the large width.

Further, it is not always necessary that a plurality of cold cathode fluorescent lamps 21 which are arranged in the inside of one side surface are arranged in the direction perpendicular to the display surface of the liquid crystal display panel 2. That is, so long as a plurality of cold cathode fluorescent lamps 21 are respectively arranged at positions whose distance from the display surface are different from each other, their horizontal positions may be different from each other.

Further, the case in which the present invention is applied to the TFT type liquid crystal display device has been explained in the above-mentioned respective embodiments, the application of the present invention is not limited to such a case. It is needless to say that the present invention is also applicable to a STN type simple-matrix type liquid crystal display device.

Although the present invention made by inventors of the present invention has been specifically explained in conjunction with the above-mentioned embodiments of the present invention, the present invention is not limited to the above-mentioned embodiments and various modification can be conceived without departing from the spirit of the present invention.

To briefly explain advantageous effects brought about by typical inventions disclosed in the present application, they are as follows.

According to the present invention, in the liquid crystal display device which adopts the sidelight backlight unit in which a plurality of light sources are arranged, it becomes possible to prevent the phenomenon that the temperature of each light source is elevated due to the radiation heat from the other light source and the brightness of respective light sources is reduced.

Due to such a constitution, the brightness of the display images displayed on the liquid crystal display element can be enhanced.

What is claimed is:

1. A liquid crystal display device comprising a liquid crystal display element having a pair of substrates and liquid crystal sandwiched between a pair of substrates and a backlight unit which is arranged at a side opposite to a display surface of the liquid crystal display element,
the backlight unit comprising:
a light guide body,
a plurality of light sources which are arranged at least along one side surface of the light guide body at a plurality of positions whose distances from a display surface of the liquid crystal display element are different from each other and irradiate the irradiation light to the liquid crystal display element,
a reflection member which covers a plurality of light sources and has shielding means which is arranged between each two light sources of a plurality of light sources, and
a housing member which houses the light guide body, a plurality of light sources and the reflection member.

2. A liquid crystal display device according to claim 1, wherein at least two light sources are arranged along one side surface of the light guide body, and
at least two more light sources are arranged along another side surface of the light guide body which are disposed opposite to the one side surface of the light guide body.

3. A liquid crystal display device according to claim 1, wherein surfaces of the reflection member and the shielding means which face the respective light sources in an opposed manner form reflection surfaces.

4. A liquid crystal display device according to claim 1, wherein the reflection member and the shielding means are made of metal.

5. A liquid crystal display device according to claim 4, wherein the housing member is at least partially made of metal and the reflection member is thermally connected with the metal portion of the housing member.
